(19) United States
(12) Patent Application Publication
(10) Pub. No.: US 2016/0248364 A1
(43) Pub. Date: Aug. 25, 2016

(54) VARIABLE SPEED DRIVE WITH TOPSIDE CONTROL AND SUBSEA SWITCHING

(71) Applicant: ONESUBSEA IP UK LIMITED, London (GB)

(72) Inventor: Audun Magne Askeland, Bergen (NO)

(21) Appl. No.: 14/631,612

(22) Filed: Feb. 25, 2015

(51) Int. Cl. H02P 27/06; E21B 43/01; H02J 5/00; E21B 43/12

(52) U.S. Cl. CPC H02P 27/06; E21B 43/121; E21B 43/01; H02J 5/00

(57) ABSTRACT

According to some embodiments, functionality of a conventional variable speed drive (VSD) for driving a subsea electric motor is “split” with the CPU with frequency converter control being located topside and the low-level switching hardware being located subsea with the subsea motor. The motor can be used, for driving a pumping or other fluid processing module in a subsea oil or gas field.

### TECHNICAL FIELD

The present disclosure relates to control of subsea electric motors. More particularly, the present disclosure relates to control of subsea electric motors driven by a subsea variable speed drive.

### BACKGROUND

In subsea applications, for example subsea fluid processing in the oil and gas industry, subsea motors are used to carry out certain fluid processing tasks such as to power fluid pumps and compressors. Conventionally, the subsea motor is controlled by a topside variable speed drive (VSD) that generates varying frequency three-phase power transmitted through an umbilical cable system to the subsea location where the subsea motor is located. Additionally, especially in cases of long umbilical cable distances, a topside step-up transformer and subsea step-down transformer may be used to reduce energy losses through the umbilical.

Entire VSD systems can be deployed subsea, which can be beneficial, for example, in cases of very long tiebacks and/or multiple consumers. With a subsea VSD, power in form of A/C or D/C electricity is transmitted through the umbilical, and a subsea VSD converts the power to variable A/C for driving the subsea motor. With subsea VSDs, however, the control circuitry needs to be qualified for long-term subsea installation, since any failures may result in very costly intervention procedures. Proposed designs include control electronics which generate the pulse width modulated signals, etc. and are located in an air-filled atmospheric enclosure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a system is described for operating a subsea electric motor. The system includes: a subsea electric induction motor installed in a subsea location; a surface control system configured to adjust operating speed of the subsea electric motor by outputting a series of control signals corresponding to a selected drive frequency; a communication system configured to transmit the series of control signals from the surface control system to the subsea location; a plurality of gate drivers deployed at the subsea location and configured to receive the series of control signals and output corresponding gate voltages; and a plurality of semiconductor active switches deployed at the subsea location and configured to receive the gate voltages and in combination convert a source power into pulse-width modulated quasi-sinusoidal alternating currents (AC) at the selected drive frequency thereby driving the motor at the selected drive frequency.

According to some embodiments, a subsea high-speed de-multiplexer is deployed at the subsea location and configured to distribute the series of control signals to the plurality of gate drivers. The communication system can use one or more optical fibers to transmit the series of control signals. In some cases the semiconductor active switches are gate-controlled semiconductor switching devices, including for example, insulated-gate bipolar transistor (IGBT) switching devices, integrated gate-commutated thyristor (IGCT) switching devices or gate turn-off thyristor (GTO) switches.

According to some embodiments, the source power is transmitted as three-phase electric power from the surface to the subsea location, and a diode bridge rectifier system converting the three-phase electric power into direct current (DC) electric power for use by the switches. In some cases, a subsea step-down transformer is used to reduce voltage levels of the transmitted three-phase electric power for use by the diode bridge rectifier system. In some cases, the source power is transmitted as DC electric power from the surface to the subsea location. In some cases, the rectifier system can be designed with active switches, thereby providing an active front end that is controlled by a surface system.

According some cases, the parts of the system that are located in the subsea location are free from digital control electronics and/or are free from any gas-filled sealed housings. According to some embodiments, the electric motor is used to drive fluid processing equipment such as a subsea pump, a subsea compressor, or a subsea separator. The fluid being processed can be produced from a subterranean hydrocarbon-bearing reservoir. According to some embodiments, the surface control system is capable of providing continuously variable control over the frequency of the motor.

According to some embodiments, a system is described for controlling a subsea electric motor. The system includes: a surface control system configured to adjust operating speed of a subsea electric motor by outputting a series of control signals corresponding to a selected drive frequency; a communication system configured to transmit the series of control signals from the surface control system to the subsea location; a plurality of gate drivers deployed at the subsea location and configured to receive the series of control signals and output corresponding gate voltages; and a plurality of semiconductor active switches deployed at the subsea location and configured to receive the gate voltages, and in combination convert a source power into pulse-width modulated quasi-sinusoidal alternating current (AC) at the selected drive frequency thereby driving the motor at the selected drive frequency, wherein the portion of the system in the subsea location is free from digital control electronics.

According to some embodiments, a method is described for controlling a subsea electric motor. The method includes: at a surface location, selecting a drive frequency; using a surface control system, generating a series of pulse-width modulated gate control signals which correspond to the selected drive frequency; transmitting the series of gate control signals to a subsea location where a subsea motor is deployed; in the subsea location, distributing the series of gate control signals to a plurality of gate drivers; using the gate drivers, converting the gate control signals into gate control voltages; and driving the electric motor by inputting the gate control voltages to a plurality of semiconductor active switches deployed at the subsea location, and converting a source power into three pulse width modulated quasi-sinusoidal alternative currents at the selected drive frequency.

According to some embodiments, one or more of the described systems and/or methods can be used in topside or subsea fluid processing equipment in an analogous fashion.

According to some embodiments, the techniques described herein are applicable to any subsea converters where gate controlled semiconducting switches are used. Examples of subsea settings where topside control signals can be used to control subsea switching include: high-voltage, direct current (HVDC) electric power transmission systems; subsea DC-DC converters; subsea uninterruptible power supply (UPS) systems; subsea semiconducting circuit breakers; and subsea VAR compensator systems.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 is a diagram illustrating topside and subsea environments in which a subsea motor driven by a VSD having topside control and subsea switching can be deployed, according to some embodiments; and

FIG. 2 is a block diagram illustrating further aspects a subsea motor driven by a VSD having topside control and subsea switching, according to some embodiments.

### DETAILED DESCRIPTION

The particulars shown herein are by way of example, and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements.

According to some embodiments, a subsea motor can be controlled using subsea deployed gate drivers and semiconductor switches, but with the control electronics located in topside surface facility. Such an arrangement avoids many of the drawbacks associated with deploying the entire variable speed drive (VSD) system in the subsea location. The control electronics, or “the brain” of the VSD which includes a CPU and various other frequency converter circuitry include many of the components that are most prone to either failure or obsolesce over time. Repair, replacement and/or updating hardware of the control electronics is easily performed on the topside. Furthermore, according to some embodiments, locating the control electronics and CPU on the topside can avoid the use of a subsea air-filled atmospheric enclosure for protecting those components subsea. The gate drivers and semiconductor switches are easier to make pressure tolerant than the control electronics.

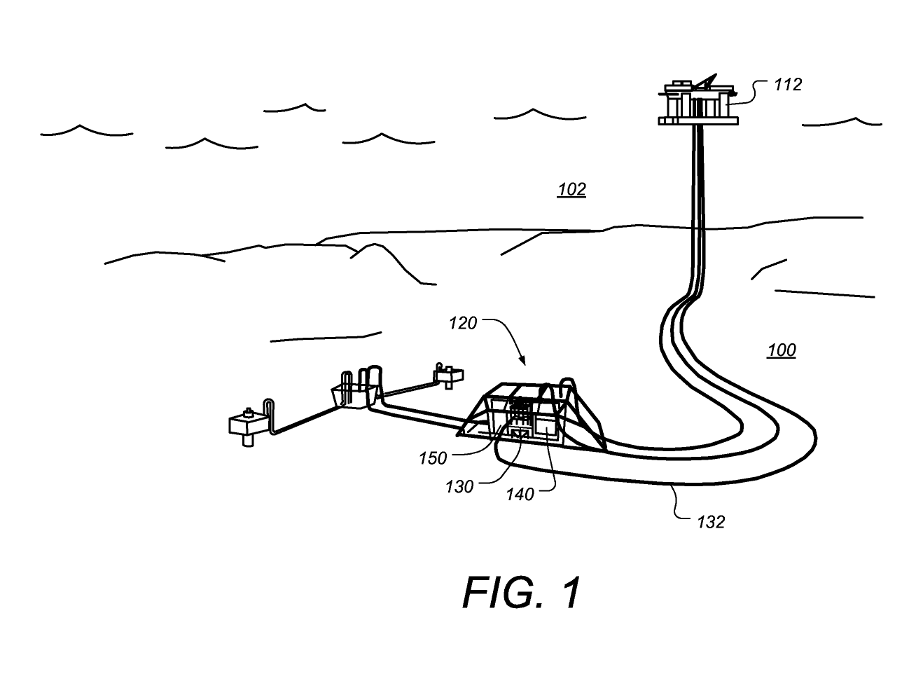

FIG. 1 is a diagram illustrating topside and subsea environments in which a subsea motor driven by a VSD having topside control and subsea switching can be deployed, according to some embodiments. On sea floor 100 a station 120 is shown which is downstream of several wellheads being used, for example, to produce hydrocarbon-bearing fluid from a subterranean rock formation. Station 120 includes a subsea pumping module 140, which is powered by an electric induction motor. The station 120 is connected to one or more umbilical cables, such as umbilical 132. The umbilicals in this case are being run from a platform 112 through seawater 102, along sea floor 100 and to station 120. In other cases, the umbilicals may be run from some other surface facility such as a floating production, storage and offloading unit (FPSO), or a shore-based facility. In many cases to reduce energy losses, it is desirable to transmit energy through the umbilicals at higher voltages than is used by the electric motors in pump module 140. Station 120 thus also includes a step-down transformer 130, which converts the higher-voltage three-phase power being transmitted over the umbilical 132 to lower-voltage three-phase power for use by pump module 140. The motor within pumping module 140 is driven with a variable speed drive (VSD) that includes topside control, within platform 112 and a subsea switching module 150. Umbilical 132 also has one or more data lines for transmission of control signals for switching module 150. According to some embodiments, the one or more data lines include one or more optical fibers. The umbilical 132 can also be used to supply barrier and other fluids, and control and other data lines for use with the subsea equipment in station 120. Although a pumping module 140 is shown in FIG. 1, according to some embodiments the VSD having topside control and subsea switching is used to drive electric motors for other applications, including subsea compressors and/or subsea separators.

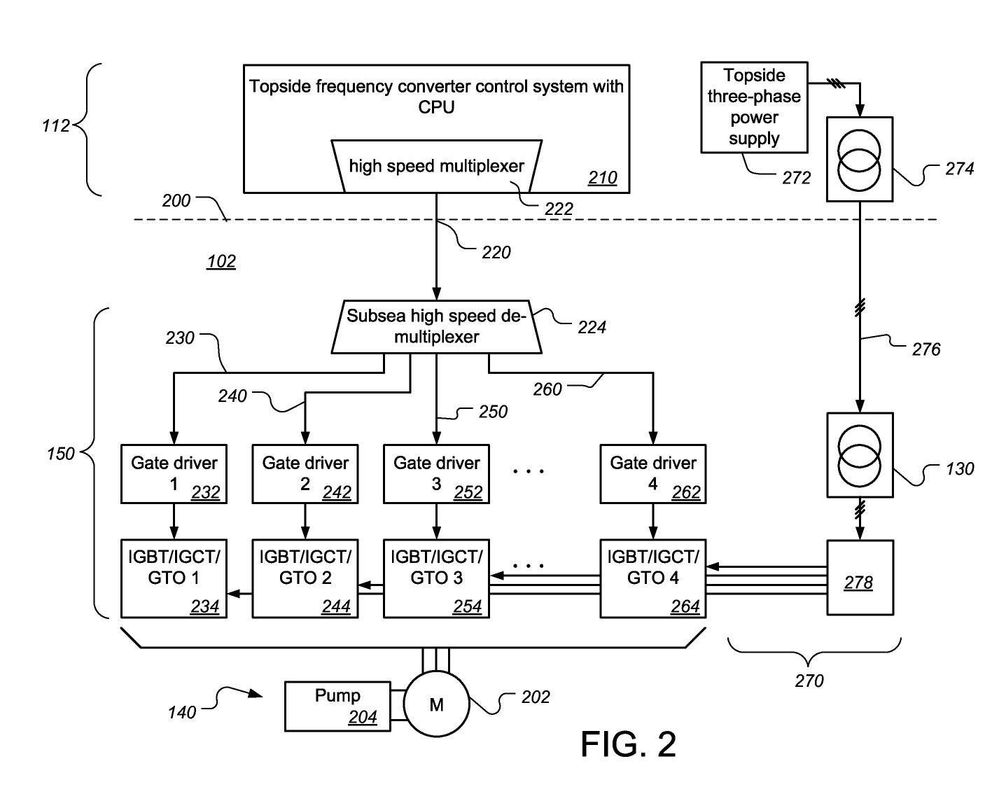

FIG. 2 is a block diagram illustrating further aspects of a subsea motor driven by a VSD having topside control and subsea switching, according to some embodiments. According to some embodiments, the functionality of a conventional VSD is “split” with the CPU with frequency converter control being located topside and the low-level switching hardware being located subsea with the subsea motor. Normally the “brain” of the converter with CPU, IO, and Communication etc., is located in the same “cabinet” or enclosure as the entire frequency converter. For subsea applications this means a number of circuit boards and other electronic components need to be subsea qualified. Furthermore, any failures tend to be rather significant since an intervention is likely to be used to replace the circuitry. A conventional frequency converter is multipurpose, where some applications rely on high-speed control. In such applications it is important to have low time-delay between the control system doing the calculations and the switching elements in the inverter. However, in many subsea applications, most or all of the loads are motors for pumps and the like, which do not rely on such high speed. Therefore, it has been found that it is in many cases acceptable to put the control system with the calculations and control algorithms topside, leaving only the gate-drivers and a multiplexer subsea.

According to some embodiments, at the surface platform 112, the “brain” of the VSD is located, namely the topside frequency converter control system with CPU 210. According to some embodiments, control system 210 includes a CPU, I/O, and communications, and a user interface (e.g. a keypad interface and display). The control system 210 sets (or receives instructions for) the operating speed of the electric motor 202 that drives subsea pump 204 in subsea pump module 140. According to some embodiments, the control system 210 generates pulse-width modulated control signals that cause subsea switching module 150 to generate sine-like voltage waveforms for each of three-phases in order to drive motor 202 at the selected frequency. According to some embodiments, switching patterns other than pulse-width modulation are used, such as for example: customized pulse patterns, hysteresis switching patterns and other switching patterns. By locating control system 210 (including the brain/CPU) topside, the system is flexible in that control signals generated using various methods and different manufacturers/vendors can be paired with the general subsea switching module 150.

According to some embodiments, the control signals generated by control system 210 are multiplexed using high-speed multiplexer 222 on the surface such that the signals can be sent via a single fiber optic communication link 220 through the seawater surface 200 to the subsea station (e.g. station 120 in FIG. 1) where switching module 150 and pump module 140 are located. The multiplexed control signals are received by subsea high-speed de-multiplexer 224 which distributes the control signals via optical fiber links 230, 240, 250 and 260 to gate drivers 232, 242, 252 and 262. The gate drivers in response to the control signals generate the appropriate gate voltages and currents to switch (turn on or off) the semiconductor power switches 234, 244, 254 and 264. The power switches, operated according to the gate driver signals, generate the three phase pseudo-sine wave AC voltages driving motor 202 in pump module 140. Note that although four gate driver/switches are shown, in general there will be different numbers depending on the particular application. Generally, there will be at least 6 gate drivers and semiconductor switches although in some cases there can be much greater numbers. Also, according to some embodiments, various types of gate-controlled semiconducting switches can be used such as: insulated-gate bipolar transistor (IGBT); integrated gate-commutated thyristor (IGCT); and/or gate turn-off thyristor (GTO) switching devices.

Also shown in FIG. 2 according to some embodiments is supply power system 270 that includes a topside three-phase power supply 272 and topside step-up transformer 274. The high-voltage power is transmitted to the subsea station via electrical power transmission lines 276 within an umbilical (such as umbilical 132 shown in FIG. 1). System 270 also includes subsea step-down transformer 130 and rectifier system 278, which converts the three-phase power to DC current for use by semiconductor power switches 234, 244, 254 and 264. According to some embodiments, rectifier system 274 is a diode bridge rectifier system that is configured to convert the three-phase electric power into direct current (DC). According to some other embodiments, rectifier system 278 is configured with active switching capability using gate drivers and semiconductor switches that are similar or identical to those used in switching module 150. In such cases, the “active front end” rectifier system 278 can be controlled using a topside CPU/brain that is similar or identical to control system 210 in the manner described herein. Such active front end system may be desirable in some situations such as, for example, where regenerative braking is used or in cases where current source converters (e.g. LCI-converters) are used.

The components of switching module 150, namely the demultiplexer 224, gate drivers 232, 242, 252 and 262 and semiconductor power switches 234, 244, 254 and 264 are easier to make pressure tolerant than the components in control system 210. In some cases the components of switching module 150 are pressure compensated in an oil-filled enclosure. In such cases the use of a subsea gas-filled enclosure can be avoided altogether. Even in cases where some or all of the components of switching module 150 are contained in a gas-filled enclosure, there are far fewer components in the enclosure in comparison to designs that locate the control system electronics subsea.

According to some embodiments the transformers 274 and 130 are not used. According to some other embodiments, multiplexer 222 and demultiplexer 224 are not used. In such cases, the communication link 220 includes one or two optical fibers for each gate driver.

Although the embodiments described in FIGS. 1 and 2 thus far are in the context of a subsea pumping module for developing subsea oil and gas, according to some embodiments, the techniques described herein are applicable to any subsea converters where gate-controlled semiconducting switches are used. Examples of subsea settings where topside control signals can be used to control subsea switching include: high-voltage, direct current (HVDC) electric power transmission systems; subsea DC-DC converters; subsea uninterruptible power supply (UPS) systems; subsea semiconducting circuit breakers; and subsea VAR compensator systems.

While the subject disclosure is described through the above embodiments, it will be understood by those of ordinary skill in the art that modification to and variation of the illustrated embodiments may be made without departing from the inventive concepts herein disclosed. Moreover, while some embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A system for operating a subsea electric motor comprising:
a subsea electric motor installed in a subsea location;
a surface control system configured to adjust operating speed of said subsea electric motor by outputting a series of control signals corresponding to a selected drive frequency;
a communication system configured to transmit the series of control signals from the surface control system to the subsea location;
a plurality of gate drivers deployed at the subsea location and configured to receive said series of control signals and output corresponding gate signals; and
a plurality of semiconductor switches deployed at the subsea location and configured to receive said gate signals and convert a source power into alternating currents (AC) at said selected drive frequency thereby driving said motor at said selected drive frequency.

2. The system according to claim 1 wherein the alternative currents are quasi-sinusoidal pulse-width modulated.

3. The system according to claim 1 further comprising a subsea high-speed de-multiplexer deployed at the subsea location and configured to distribute the series of control signals to said plurality of gate drivers.

4. The system according to claim 1 wherein said communication system uses one or more optical fibers to transmit said series of control signals.

5. The system according to claim 1 wherein each of said semiconductor switches is selected from a group consisting of: a gate-controlled semiconducting switch, an insulated-gate bipolar transistor (IGBT) switching device, an integrated gate-commutated thyristor (IGCT) switching device and a gate turn-off thyristor (GTO) switch.

6. The system according to claim 1 wherein said source power is transmitted as three-phase electric power from the surface to the subsea location and the system further comprises a rectifier system that converts the three-phase electric power into direct current (DC) electric power for use by said switches.

7. The system according to claim 6 wherein the system further comprises a subsea transformer configured to reduce voltage levels of the transmitted three-phase electric power for use by said rectifier system.

8. The system according to claim 1 wherein said source power is transmitted as DC electric power from the surface to the subsea location.

9. The system according to claim 1 wherein the motor is configured to drive fluid processing equipment of a type selected from a group consisting of: subsea pump, subsea compressor, and subsea separator.

10. The system according to claim 9 wherein the fluid processing equipment is configured for processing a fluid produced from a subterranean hydrocarbon-bearing reservoir.

11. The system according to claim 1 wherein the surface control system is further configured to provide continuously variable control over the frequency of the motor.

12. A system for controlling a subsea electric motor comprising:
a surface control system configured to adjust operating speed of a subsea electric motor by outputting a series of control signals corresponding to a selected drive frequency;
a communication system configured to transmit the series of control signals from the surface control system to a subsea location where the subsea electric motor is deployed;
a plurality of gate drivers deployed at the subsea location and configured to receive said series of control signals and output corresponding gate signals; and
a plurality of semiconductor switches deployed at the subsea location and configured to receive said gate signals and convert a source power into pulse-width modulated alternating current (AC) at said selected drive frequency thereby driving said motor at said selected drive frequency.

13. The system according to claim 12 further comprising a subsea high-speed de-multiplexer deployed at the subsea location and configured to distribute the series of control signals to said plurality of gate drivers.

14. The system according to claim 12 wherein said communication system uses one or more optical fibers to transmit said series of control signals.

15. The system according to claim 12 wherein each of said semiconductor active switches is an insulated-gate bipolar transistor (IGBT) switching device.

16. A system for controlling a plurality of subsea gate-controlled semiconducting switches comprising:
a surface control system configured to output a series of control signals;
a communication system configured to transmit the series of control signals from the surface control system to a subsea location;
a plurality of gate drivers deployed at the subsea location and configured to receive said series of control signals and output corresponding gate voltages; and
a plurality of gate-controlled semiconducting switches deployed at the subsea location and configured to open and close in a pattern that corresponds to the received gate voltages.

17. A system according to claim 16 wherein the pattern of opening and closing of the plurality of gate-controlled semiconducting switches convert a source power into alternating currents (AC) which drives a subsea electric motor.

18. A system according to claim 16 wherein the gate-controlled semiconducting switches are used in a system of a type selected from a group consisting of: high-voltage direct current (HVDC) electric power transmission system; subsea DC-DC converter; subsea uninterruptible power supply (UPS) system; subsea semiconducting circuit breaker; and subsea VAR compensator system.

19. A method for controlling a subsea electric motor comprising:
at a surface location selecting a selected drive frequency;
using a surface control system, generating a series of gate control signals which correspond to the selected drive frequency;
transmitting the series of gate control signals to a subsea location where a subsea motor is deployed;
in the subsea location, distributing the series of gate control signals to a plurality of gate drivers;
using the gate drivers, converting the gate control signals into gate control voltages; and
driving the electric motor by inputting said gate control voltages to a plurality of semiconductor switches deployed at the subsea location and converting a source power into modulated alternative currents at said selected drive frequency.

20. The method according to claim 19 further comprising distributing, using a de-multiplexer deployed at the subsea location, the series of gate control signals to said plurality of gate drivers.

21. The method according to claim 19 wherein said transmitting uses one or more optical fibers to transmit said series of gate control signals.

22. The method according to claim 19 wherein each of said semiconductor active switches is an insulated-gate bipolar transistor (IGBT) switching device.

23. The method according to claim 19 further comprising:
transmitting said source power as three-phase electric power from the surface to the subsea location; and
rectifying said three-phase transmitted source power using a rectifier system into direct current (DC) electric power for use by said switches.

24. The method according to claim 23 further comprising reducing voltage levels of the transmitted three-phase electric power for use by said rectifier system using a subsea step-down transformer.

25. The method according to claim 19 further comprising processing a fluid using the motor, using one or more processing types selected from a group consisting of: subsea pumping, subsea compressing, and subsea separating.
